(19) United States
(12) Patent Application Publication
(10) Pub. No.: US 2026/0261905 A1
(43) Pub. Date: Sep. 3, 2026

(54) TECHNIQUE FOR BUFFER STATUS CONFIGURATION

(71) Applicant: Telefonaktiebolaget LM Ericsson (publ), Stockholm (SE)

(72) Inventors: Nianshan SHI, JÄRFÄLLA (SE); Mohammed Yazid LYAZIDI, LONDON (GB); Du Ho KANG, SOLLENTUNA (SE); Jose Luis PRADAS, STOCKHOLM (SE)

(73) Assignee: Telefonaktiebolaget LM Ericsson (publ), Stockholm (SE)

(21) Appl. No.: 19/162,945

(22) PCT Filed: Mar. 7, 2024
(86) PCT No.: PCT/EP2024/056107

§ 371 Date: Sep. 7, 2025

Related U.S. Application Data
(60) Provisional application No. 63/450,624, filed on Mar. 7, 2023.

(51) Int. Cl. H04W 28/02

(52) U.S. Cl. CPC H04W 28/0278; H04W 28/0268

(57) ABSTRACT

A technique for configuring a buffer status report, BSR, is described. As to a method aspect of the technique performed by a central unit, CU, of a network node of a radio access network, RAN, a control message is received from a distributed unit, DU, the control message comprising BSR information related to a configuration of a BSR to be reported by a radio device. A configuration message is sent to the radio device, the configuration message being indicative of the configuration of the BSR to be reported by the radio device.

### TECHNICAL FIELD

The present disclosure relates to a technique for configuring buffer status reporting. More specifically, and without limitation, methods and devices are provided for configuring a buffer status report (BSR) and for assisting in the configuring of the BSR. An example for the configuring of the BSR includes configuring a buffer status table for the BSR.

### BACKGROUND

The Third Generation Partnership Project (3GPP) specifies radio access technologies (RATs) such as Fifth Generation (5G) New Radio (NR). In many RATs, a Buffer Status Report (BSR) is a mechanism used by a radio device (i.e., a User Equipment or UE) to inform a network node (e.g., a next generation node B or gNB) of a radio access network (RAN) as to the amount of data the radio device has waiting to be transmitted. The network node uses the BSR as input for efficient resource allocation and scheduling.

The UE sends BSRs periodically or when triggered by certain events, such as the buffer reaching a certain threshold. The BSR includes information such as the size of the data buffer, the amount of data waiting to be transmitted, and the priority of the data.

The BSR is also used by the network node to determine when to trigger a retransmission of lost or corrupted data. By monitoring the BSR, the network node can detect when there is data waiting to be transmitted in the buffer of the radio device and can request a retransmission if necessary.

The network node can be split into functional entities to improve the flexibility and scalability of the RAN. One such split is the split between a Central Unit (CU) and one or more Distributed Units (DU).

The CU is responsible for higher-layer functions such as mobility management, radio resource management, and connection management. On the other hand, the DU is responsible for lower-layer functions such as digital signal processing, modulation, and demodulation. The DU communicates with the radio hardware and performs physical layer functions such as beamforming, channel coding, and decoding as well as medium access control (MAC) functions such as scheduling. The DU can be further divided into a Front-Haul (FH) and a Radio Unit (RU), where the FH handles the transport of data between the RU and the DU, and the RU handles the RF functions.

Currently, the buffer status (BS) tables of the BSR are hardcoded in the specifications and, thus, there is no possibility for change or update. In Release 18, 3GPP is discussing to introduce other or further BS tables. These BS tables could be static i.e., hardcoded in the specifications, or dynamic i.e., configurable by the RAN. But even in case the BS tables are dynamic, the distributed unit (DU) of a network node receives and uses buffer status reports (BSR) from radio devices (e.g., UEs), e.g. for scheduling of the radio devices, while the central unit (CU) of the network node configures the radio devices as to which type of buffer status report (e.g., which type of BS table) is to be reported. Accordingly, with the existing technique, it is not possible for the DU to change the type of BSR, e.g. as needed for appropriate scheduling or in response to a change in scheduling strategy or scheduling requirements.

### SUMMARY

Accordingly, there is a need for a technique that enables or improves signaling and configuring buffer status reports (BSRs), e.g. buffer status tables (BS tables), in a split network node architecture (e.g. split gNB) of a radio access network (RAN).

As to a first method aspect, a method performed by a central unit (CU) of a network node of a radio access network (RAN) is provided. The method comprises receiving a control message from a distributed unit (DU). The control message comprises BSR information related to a configuration of a buffer status report (BSR) to be reported by a radio device. Alternatively or in addition, the method comprises sending a configuration message to the radio device. The configuration message may be indicative of a configuration (e.g., the configuration) of the BSR to be reported by the radio device.

The first method aspect may be implemented alone or in combination with any one of the embodiments disclosed herein, particularly the CU embodiments.

The DU may be associated with the CU. Alternatively or in addition, CU and DU may be part of the same network node.

A midhaul network and/or an F1 interface and/or an F1 application protocol (F1AP) may be used for control signaling (e.g., assistance information and/or the control message) between the DU and the CU. The F1 interface may provide means for interconnecting the CU (e.g., a gNB-CU) and the DU (e.g., a gNB-DU) of the network node (e.g., a gNB) within the RAN (e.g., an NG-RAN), or for interconnecting a gNB-CU and a gNB-DU of an en-gNB within an E-UTRAN. The F1 Application Protocol (F1AP) may support the functions of the F1 interface by signaling procedures defined in the 3GPP document 3GPP TS 38.473, version 17.3.0, or a modification thereof.

Embodiments of the technique may be used for the BSR comprising one or more buffer status (BS) tables of the BSR that are not static (e.g., not hardcoded in specifications) and/or dynamic (e.g., configurable by the network node). In case the BS tables are dynamic, embodiments of the technique can enable network signaling between network nodes and/or enable updating and changing the one or more BS tables and/or communicating these changes to the radio device. Furthermore, in split network node (e.g., split gNB) architecture, the BSR information (also referred to as buffer status information) may be detected (e.g., determined) by the DU. A radio resource control (RRC) configuration of the radio device may be performed by the CU as a physical or logical entity separate from the DU. For example, when the DU changes a BS table for the BSR, embodiments enable the network node (e.g., a NG-RAN node) to update the BSR configuration of the radio device accordingly for the BS table.

The configuration indicated by the configuration message may be dependent on the BSR information comprised in the control message. The configuration of the BSR may be partly or completely determined by the information comprised in the control message. In that sense, the BSR information may be related to the configuration, e.g. for the configuration.

The configuration of the BSR may be a configuration of the reporting of a buffer status (BS). The configuration of the BSR may be indicative of a condition (e.g., time rule or event criterion) for the radio device to transmit the BSR (e.g., to the DU). Alternatively or in addition, the configuration of the BSR may be indicative of information that is to be included in the BSR (i.e., information that is to be reported). Alternatively or in addition, the configuration of the BSR may be indicative of a format that is to be used for the BSR.

The BSR information and/or the configuration of the BSR may specify when the radio device sends BSRs periodically or when triggered by certain events. For example, the BSR information and/or the configuration of the BSR may specify threshold values for such an event being the buffer reaching the threshold value. Alternatively or in addition, the BSR information and/or the configuration of the BSR may specify which information is included in the BSR such as the size of the data buffer, the amount of data waiting to be transmitted, and the priority of the data.

In wireless communication systems (e.g., according to the Third Generation Partnership Project, 3GPP, such as Long-Term Evolution, LTE, and New Radio, NR), the Buffer Status Report (BSR) may be a message transmitted by the radio device (e.g., a User Equipment, UE) to the RAN (e.g., the network node, specifically, to the DU) to inform of the amount of data pending (e.g., waiting or available) for transmission (e.g., uplink transmission or sidelink transmission) in one or more buffers at the radio device.

Based on the BSR, the network node (e.g., the DU) or a secondary node (SN) may allocate (e.g., schedule) radio resources to the radio device. The BSR may be transmitted from the radio device, e.g. periodically or when there is a significant change in the amount of buffered data, such as when a new data flow is established (i.e., becomes available) or an existing data flow is terminated.

In an embodiment, the control message is indicative of the radio device and/or the BSR information may be specific for the radio device. Alternatively or in addition, the control message is indicative of a logical channel group (LCG) and/or the BSR information may be specific for a logical channel group. Alternatively or in addition, the BSR information may apply to all radio devices radio-connected to or through the DU.

In an embodiment, the control message may be received from the DU of the network node. Alternatively or in addition, the control message may be received from the DU of a secondary node (SN) other than the network node. Optionally, the network node as a master node (MN) and the SN may provide dual connectivity (DC) to the radio device.

In an embodiment, the radio device may be radio-connected to the DU or through the DU.

The DU may perform radio communications protocols according to at least one of a physical layer (PHY layer), a medium access control (MAC) layer and a radio link control (RLC) layer of a protocol stack.

In an embodiment, the BSR information comprised in the received control message may be indicative of one or more channel condition network parameters and/or application traffic statistics. Alternatively or in addition, the BSR information comprised in the received control message may be indicative of a threshold value for measurement data or statistics of the measurement data measured at the CU. Alternatively or in addition, the method further may comprise determining the configuration of the BSR based on the received BSR information or changing the BSR configuration if the measured data or the measured statistics exceeds or falls below the threshold value.

The network parameters and/or application traffic statistics may refer to a usage of resources of the RAN (e.g. radio resources or network resources of the DU), e.g. a bit rate of the traffic or a required bit rate; and/or a block error rate (BLER) or a BLER requirement (i.e., reliability requirement); and/or a latency or a latency requirement. Traffic may refer to an amount of data transmitted and/or received by the radio device. Alternatively or in addition, the network parameters and/or application traffic statistics indicated in the control message may be based on measurements at the DU. The channel condition may refer to signal strength, and/or noise power, and/or interference (e.g. as measured at the DU), e.g. a signal to noise ratio (SNR) or a signal to noise and interference ratio (SINR).

For example, the BSR information may trigger a change of the BSR configuration (e.g., a change of the buffer status table) used in the BSR responsive to a change of an application (e.g., a service) performed or used by the radio device. For example, the BSR information may be sent by the DU to the CU when an extended reality (XR) application is performed or used by the radio device.

In an embodiment, the BSR information comprised in the received control message and/or the configuration indicated in the sent configuration message may be indicative of a change of a buffer status table to be used in the BSR.

Alternatively or in addition, the BSR information comprised in the received control message and/or the configuration indicated in the sent configuration message may be indicative of a configuration of a buffer status table. Alternatively or in addition, the BSR information comprised in the received control message and/or the configuration indicated in the sent configuration message may be indicative of a buffer status table to be used in the BSR from the radio device, optionally an index of the buffer status table. Alternatively or in addition, the BSR information comprised in the received control message and/or the configuration indicated in the sent configuration message may be indicative of a step size of a buffer size range reported in the BSR, optionally an index for the step size. Alternatively or in addition, the BSR information comprised in the received control message and/or the configuration indicated in the sent configuration message may be indicative of a number of steps of a buffer size range reported in the BSR, optionally an index for the step size. Alternatively or in addition, the BSR information comprised in the received control message and/or the configuration indicated in the sent configuration message may be indicative of a minimum value of a buffer size range reported in the BSR, optionally an index for the minimum value. Alternatively or in addition, the BSR information comprised in the received control message and/or the configuration indicated in the sent configuration message may be indicative of a maximum value of a buffer size range reported in the BSR, optionally an index for the maximum value.

The BSR information comprised in the received control message may be a BSR table information indicative of a buffer status table to be used in the BSR from the radio device.

Per buffer size range, a range index may be indicative of at least two of step size, number of steps, minimum value, and/or maximum value. In other words, the configuration of buffer size range may be indicated by a range index. Alternatively or in addition, a table index may be indicative of the buffer status table. For example, a pair of indices may indicate the table and the configuration for range for each table, respectively. Alternatively or in addition, the single index may be indicative of the table and the configuration for the range. In other words, the table and the range may be jointly configured (i.e., jointly indicated).

Herein, buffer size may refer to an amount of data (e.g., currently) stored in a buffer (e.g., as opposed to the storage capacity of the buffer).

In an embodiment, the BSR information comprised in the received control message and/or the configuration indicated in the sent configuration message may be indicative of whether a packet delay budget (PDB) of data pending at the radio device is to be included in the BSR. Alternatively or in addition, the BSR information comprised in the received control message and/or the configuration indicated in the sent configuration message may be indicative of whether a delay of data pending at the radio device is to be included in the BSR. Alternatively or in addition, the BSR information comprised in the received control message and/or the configuration indicated in the sent configuration message may be indicative of whether a remaining time budget of data pending at the radio device is to be included in the BSR.

The PDB may specify a maximum end-to-end delay that is allowed for a particular application (e.g., service). The PDB may be used to determine an overall latency requirement for the network (e.g., including the RAN).

The remaining time budget may be a residual of the PDB or a Time Aware Shaper (TAS) Credit. The TAS Credit may be used to ensure that the transmission of Time-Sensitive Networking (TSN) traffic conforms to a specified PDB by dynamically adjusting the transmission rate of the traffic based on the remaining time budget.

The TAS Credit is essentially a mechanism for managing the time available for transmitting TSN traffic, and it is used to ensure that the overall latency requirements of the network are met. By adjusting the transmission rate of the traffic based on the remaining time budget, the TAS Credit is a control parameter to prevent delays that could exceed the specified PDB. This mechanism may be implemented at the radio device using the BSR and/or at the DU scheduling the radio device.

In an embodiment, the BSR information comprised in the received control message and/or the configuration indicated in the sent configuration message may be indicative of a BSR triggering condition for triggering the radio device to transmit the BSR.

In an embodiment, the method may further comprise sending assistance information from the CU to the DU. The control message may be received in response to the sent assistance information.

In an embodiment, the assistance information may be indicative of measurement data or statistics of the measurement data. Optionally, the measurement data may comprise at least one of network parameters, application traffic of the radio device, sizes of protocol data units (PDUs) transmitted by the radio device. Alternatively or in addition, the statistics may comprise statistics on network parameters, statistics on application traffic of the radio device, statistics of PDU sizes, optionally a minimum size or a maximum size or an average size or size distribution.

Alternatively or in addition, the assistance information may be indicative of a requirement of the radio device and/or a quality of service (QoS) required by an application performed by the radio device or a service used by the radio device and/or PDU size requirement.

Alternatively or in addition, the assistance information may be indicative of an update frequency with which the BSR configuration or the buffer status table is to be updated, and/or a validity for how long the BSR configuration or the buffer status table applies, and/or one or more logical channel identity (LCIDs) for which a buffer status table is applicable or is to be updated, and/or a one or more radio devices for which the buffer status table applies or is to be updated.

The measurement data may be measured (e.g., collected) at the CU. For example, the radio device may provide the measurement data. Alternatively or in addition, the CU determines the statistics of the measurement data. Alternatively or in addition, the CU may analyze the traffic (e.g. data packets transmitted by the radio device).

In an embodiment, the assistance information may be sent in a request message for a context of the radio device. Alternatively or in addition, the assistance information may be sent in a UE CONTEXT SETUP REQUEST message or a UE CONTEXT MODIFICATION REQUEST message.

In an embodiment, at least one of the assistance information may be sent or the control message may be received responsive to a change, for example a change in at least one of the channel condition, the network parameters, the application traffic statistics, measurement data, and the statistics of the measurement data.

For example, the assistance information may be sent or the control message may be received responsive to a change in a bit rate of an application (e.g., a service) performed or used by the radio device.

The assistance information may trigger the control message. Alternatively or in addition, the control message may trigger the configuration message.

In an embodiment, the control message may be received through an F1 interface between the CU and the DU of the network node.

In an embodiment, the received control message may be indicative of a setup or a modification of a context of the radio device. Alternatively or in addition, the received control message may be an F1 UE CONTEXT SETUP RESPONSE message or an F1 UE CONTEXT MODIFICATION RESPONSE message or an UE CONTEXT MODIFICATION REQUIRED messages.

In an embodiment, the sent configuration message may be a radio resource control (RRC) message.

In an embodiment, the sent configuration message may comprise a BSR-Config information element (IE) used to configure buffer status reporting and/or a MAC-CellGroupConfig IE comprising the configuration of the BSR.

According to a second method aspect, a method performed by a distributed unit (DU) of a network node of a radio access network (RAN) is provided. The method comprises sending a control message to a central unit (CU), the control message comprising BSR information related to a configuration of a buffer status report (BSR) to be reported by a radio device. For example, the control message triggers the CU to configure the radio device to report the BSR according to the BSR information.

The control message may trigger the CU to send a configuration message to the radio device for configuring the radio device to report the BSR according to the BSR information.

The control message may conditionally trigger the CU, e.g., if a criterion (such as a threshold value) indicated in the BSR information is fulfilled.

The second method aspect may be implemented alone or in combination with any one of the embodiments disclosed herein, particularly the embodiment of the second (method or device) aspect.

The second method aspect may further comprise any feature and/or any step disclosed in the context of the first method aspect, or a feature and/or step corresponding thereto, e.g., a receiver counterpart to a transmitter feature or step. In other words, the second method aspect may further comprise the steps or features of any embodiment of the first method aspect (e.g., any feature of the control message and/or any feature of the configuration message), or may comprise a feature or step corresponding thereto (e.g., when the second aspect sends the control message corresponding to the reception of the control message according to the first aspect).

Alternatively or in addition, the second method aspect may comprise a DU (e.g., a gNB-DU) informing (e.g., by sending the control message) a CU of BS table information (as an example of the BSR information), e.g. during an initial configuration of the radio device (e.g., UE) or upon determining or detecting a change of the BS table while the radio device is in a connected state (e.g., the RRC_CONNECTED state).

Alternatively or in addition, the first method aspect may comprise a CU (e.g., a gNB-CU), upon receiving information from a DU (e.g., the BS table information and/or the BSR information), e.g. on the BS table of the radio device, triggering a RRC Reconfiguration of the radio device (as an example of sending the configuration information).

Optionally (e.g., in the first and second method aspect), the CU (e.g., gNB-CU) may initially inform the DU (e.g., gNB-DU) of assistance information (as an example of the step of sending and receiving the assistance information in the first and second method aspects, respectively) to help build (e.g., configure) the BS table of the radio device (e.g., UE).

In Dual Connectivity (DC), the DU (e.g., gNB-DU) in a secondary node (SN) may send control message (i.e., the BSR information, e.g. the BS table information) to the CU (e.g., gNB-CU) in a master node (MN, e.g., the network node), so that the CU in the MN is triggered (e.g., enabled or forced) to include the BSR information (e.g., the BS table information) for the DU of the SN in the BSR configuration (e.g., the RRC Reconfiguration).

Alternatively or in addition (e.g., in any embodiment of the first method aspect), the step of sending the configuration message may comprise sending a signaling radio bearer (SRB, e.g. SRB type 3 or SRB3) in the SN, e.g. to convey the one or more BS tables.

Without limitation, for example in a 3GPP implementation, any “radio device” may be a user equipment (UE). Any one of the method aspects may be embodied by a method of fulfilling a required Quality of Service (QoS). The technique may be applied in the context of 3GPP New Radio (NR).

The technique may be implemented in accordance with a 3GPP specification, e.g., for 3GPP release 18. Alternatively or in addition, the technique may be implemented based on or by modifying the 3GPP document TS 38.473, version 17.3.0 and/or the 3GPP document TS 38.423, version 17.3.0.

In any radio access technology (RAT), the technique may be implemented for uplink (UL) and/or for sidelink (SL) transmission from the radio device. Alternatively or in addition, the BSR configuration may be forwarded to a remote radio device wherein the radio device acts as a relay radio device. The SL may be implemented using proximity services (ProSe), e.g. according to a 3GPP specification.

Any radio device may be a user equipment (UE), e.g., according to a 3GPP specification.

The radio device and the DU of the RAN may be wirelessly connected in an uplink (UL) and/or a downlink (DL) through a Uu interface. The radio device and the CU may be indirectly connected through the DU. Alternatively or in addition, the SL may enable a direct radio communication between proximal radio devices, e.g., the remote radio device and the relay radio device, optionally using a PC5 interface. Services provided using the SL or the PC5 interface may be referred to as proximity services (ProSe). Any radio device (e.g., the remote radio device and/or the relay radio device and/or the further radio device) supporting a SL may be referred to as ProSe-enabled radio device. The relay radio device may also be referred to as ProSe UE-to-Network Relay.

The radio device and/or the DU and/or the CU and/or the network node and/or the RAN may form, or may be part of, a radio network, e.g., according to the Third Generation Partnership Project (3GPP) or according to the standard family IEEE 802.11 (Wi-Fi). The first method aspect and the second method aspect may be performed by one or more embodiments of the network node (e.g., a base station) of the RAN, e.g. the CU and the DU, respectively.

The RAN may comprise one or more network nodes (e.g., base stations), e.g., performing the first and/or second method aspect. Alternatively or in addition, the radio network may be a vehicular, ad hoc and/or mesh network comprising two or more radio devices, e.g., acting as the remote radio device and/or the relay radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more network node (e.g., base stations).

The radio device may be wirelessly connected or connectable (e.g., according to a radio resource control, RRC, state or active mode) with the network node of the RAN.

The network node (e.g., a base station) may encompass any station that is configured to provide radio access to any of the radio devices. The network node may be referred to or may function as a cell, a transmission and reception point (TRP), a radio access node or access point (AP). The network node may provide a data link to a host computer providing the user data to the remote radio device or gathering user data from the radio device according to the BSR. Examples for the network node (e.g., base station) may include a 3G base station or Node B (NB), 4G base station or eNodeB (eNB), a 5G base station or gNodeB (gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to another aspect, a computer program product is provided. The computer program product comprises program code portions for performing any one of the steps of the first and/or second method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a device according any one of embodiments 20 to 23 is provided. The device may be configured to perform any one of the steps of the first method aspect. As to a further first device aspect, the device comprises processing circuitry (e.g., at least one processor and a memory). Said memory comprises instructions executable by said at least one processor whereby the device is operative to perform any one of the steps of the first method aspect.

According to a first device aspect, a device, e.g. a central unit (CU) of a network node, is provided. The device (e.g., the CU) comprises memory operable to store instructions and processing circuitry operable to execute the instructions, such that the central unit is operable to receive a control message from a distributed unit (DU), the control message comprising BSR information related to a configuration of a buffer status report (BSR) to be reported by a radio device. Alternatively or in addition, the device (e.g., the CU) is operable to send a configuration message to the radio device, the configuration message being indicative of the configuration of the BSR to be reported by the radio device.

The first device aspect may further be operable to perform the steps of any one of the embodiments of the first method aspect.

According to a further first device aspect, a device, e.g. a central unit (CU) of a network node, is provided. The device (e.g., the CU) is configured to perform the first method aspect.

According to second device aspect, a device, e.g., a distributed unit (DU) of a network node, is provided. The device (e.g., the DU) comprises memory operable to store instructions and processing circuitry operable to execute the instructions, such that the device (e.g., the DU) is operable to send a control message to a central unit (CU) the control message comprising BSR information related to a configuration of a buffer status report (BSR) to be reported by a radio device. The control message may be configured to trigger the CU to configure the radio device to report the BSR according to the BSR information.

The second device aspect may further be operable to perform the steps of any one of the embodiments of the second method aspect.

According to a further second device aspect, a device, e.g. a distributed unit (DU) of a network node, is provided. The device (e.g., the DU) is configured to perform the second method aspect.

As to a still further aspect a communication system including a host computer is provided. The host computer comprises a processing circuitry configured to provide user data, e.g., included in XR data or any other application data. The host computer further comprises a communication interface configured to forward the user data to a cellular network (e.g., the RAN and/or the base station) for transmission to a UE. A processing circuitry of the cellular network is configured to execute any one of the steps of the first and/or second method aspects. The UE comprises a radio interface and processing circuitry, which is configured to execute any one of the steps of the first and/or second method aspects.

The communication system may further include the UE. Alternatively, or in addition, the cellular network may further include one or more base stations configured for radio communication with the UE and/or to provide a data link between the UE and the host computer using the first and/or second method aspects.

The processing circuitry of the host computer may be configured to execute a host application, thereby providing the first and/or second data and/or any host computer functionality described herein. Alternatively, or in addition, the processing circuitry of the UE may be configured to execute a client application associated with the host application.

Any one of the UE, the devices, the CU, the DU, the network node, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for configuring a buffer status report;

FIG. 2 shows a schematic block diagram of an embodiment of a device for triggering a configuration of a buffer status report;

FIG. 3 shows a flowchart for a method of configuring a buffer status report, which method may be implementable by the device of FIG. 1;

FIG. 4 shows a flowchart for a method of triggering a configuration of a buffer status report, which method may be implementable by the device of FIG. 2;

FIG. 5 schematically illustrates an example of a radio access network comprising embodiments of the devices of FIGS. 1 and 2, respectively;

FIG. 6 schematically illustrates an example of a network node comprising embodiments of the devices of FIGS. 1 and 2, respectively;

FIG. 7 schematically illustrates a first example of a buffer status report comprising a first example of buffer status table, which may be implemented by embodiments of the devices of FIGS. 1 and 2;

FIG. 8 schematically illustrates a second example of a buffer status report comprising a second example of buffer status table, which may be implemented by embodiments of the devices of FIGS. 1 and 2;

FIG. 9 schematically illustrates an example of a cellular network comprising embodiments of the devices of FIGS. 1 and 2 for performing the methods of FIGS. 3 and 4, respectively;

FIG. 10 schematically illustrates a signaling diagram resulting from embodiments of the devices of FIGS. 1 and 2 performing the methods of FIGS. 3 and 4, respectively;

FIG. 11 shows a schematic block diagram of a central unit embodying the device of FIG. 1;

FIG. 12 shows a schematic block diagram of a distributed unit embodying the device of FIG. 2;

FIG. 13 schematically illustrates an example telecommunication network connected via an intermediate network to a host computer;

FIG. 14 shows a generalized block diagram of a host computer communicating via a base station or radio device functioning as a gateway with a user equipment over a partially wireless connection; and

FIGS. 15 and 16 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

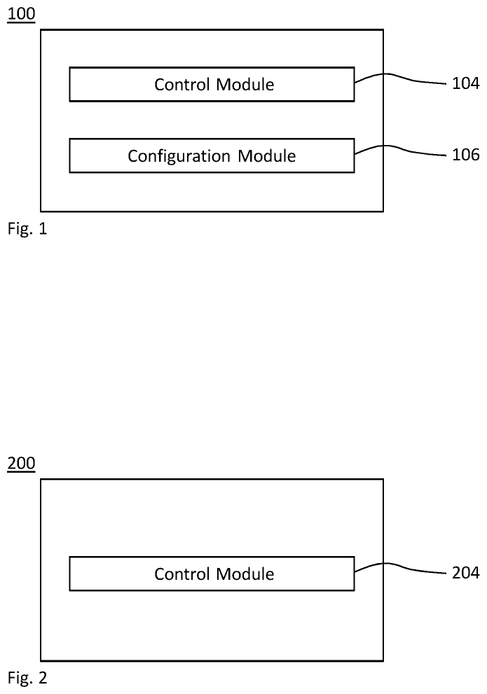

FIG. 1 schematically illustrates a block diagram of an embodiment of a device according to the first aspect, e.g. a central unit (CU) of a network node. The device is generically referred to by reference sign 100.

The device 100 comprises a control module 104 for receiving a control message. The device 100 further comprises a configuration module 106 for a buffer status report (BSR) configuration.

For example, the control module 104 receives a control message from a distributed unit (DU), wherein the control message comprises BSR information related to a configuration of a buffer status report (BSR) to be reported by a radio device. The configuration module 106 sends a configuration message to the radio device, wherein the configuration message is indicative of the configuration of the BSR to be reported by the radio device.

Any of the modules of the device 100 may be implemented by units configured to provide the corresponding functionality.

The device 100 may also be referred to as, or may be embodied by, the central unit (CU). The CU 100 and the distributed unit (DU) may be in direct communication, e.g., at least for exchanging assistance information and/or BSR information. The DU may be embodied by the below device 200.

FIG. 2 schematically illustrates a block diagram of an embodiment of a device according to the second aspect, e.g. a distributed unit (DU) of a network node. The device is generically referred to by reference sign 200.

The device 200 comprises a control module 204 for sending a control message comprising BSR information related to a configuration of a buffer status report (BSR).

For example, the control module 204 sends a control message to a central unit (CU), wherein the control message comprising BSR information related to a configuration of a buffer status report (BSR) to be reported by a radio device (904). The control message triggers the CU to configure the radio device to report the BSR according to the BSR information.

Any of the modules of the device 200 may be implemented by units configured to provide the corresponding functionality.

The device 200 may also be referred to as, or may be embodied by, the distributed unit (DU). The DU 200 and the central unit (CU) may be in direct communication, e.g., at least for exchanging assistance information and/or BSR information. The CU may be embodied by the above device 100.

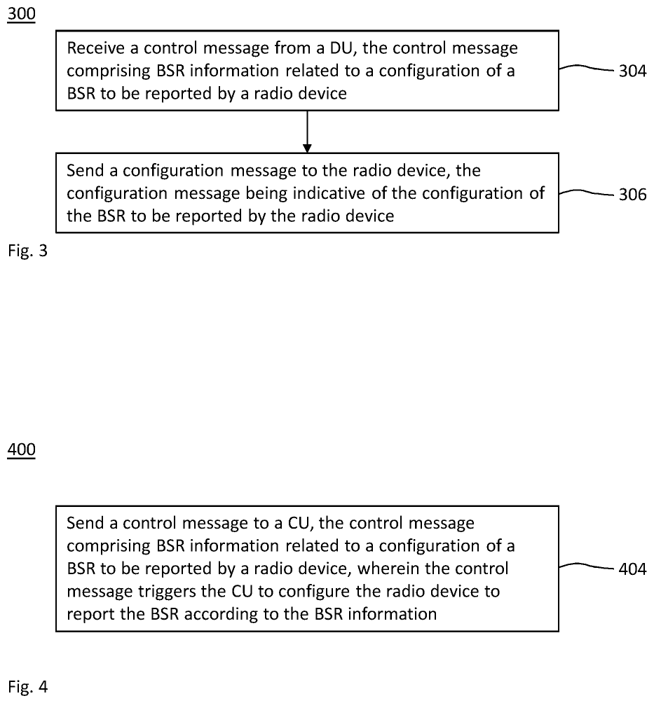

FIG. 3 shows an example flowchart for a method 300 of performing the first method aspect.

The method 300 comprises the steps 304 and 306 indicated in FIG. 3.

The method 300 may be performed by the device 100. For example, the modules 104 and 106 may perform the steps 304 and 306, respectively. An optional assistance module 102 of the device 100 may, in an optional step 302 of the method 300, send assistance information from the CU to the DU, wherein the control message is received 304 in response to the sent 302 assistance information.

FIG. 4 shows an example flowchart for a method 400 of performing the second method aspect.

The method 400 comprises the step 404 indicated in FIG. 4.

The method 400 may be performed by the device 200. For example, the module 204 may perform the step 404. An optional assistance module 202 of the device 200 may, in an optional step 402 of the method 400, receive assistance information from the CU at the DU, wherein the control message is sent 404 in response to the received 402 assistance information.

Alternatively or in addition, the first (method or device) aspect may comprise providing UE BSR assistance information from CU to DU to help the DU build the (e.g., optimal) BSR for the UE.

Alternatively or in addition, the second (method or device) aspect may comprise providing information from DU to CU, e.g. during initial UE RRC configuration, or UE RRC Reconfiguration, or when DU detects an event that triggers changes of the BS table of the UE. The BSR information according to the steps 304 and 404 may be indicative of the (e.g. new, changed or updated) BS table to the CU (e.g., gNB-CU), so that the CU can provide a new configuration to the UE according to the step 306.

Any embodiment of any aspect of the technique may use or provide BSR information sent 404 or 304 received over F1 signaling.

Further embodiments provide a solution over an Xn interface in Dual Connectivity (DC). For example, if the DU (e.g., gNB-DU) in a secondary node (SN) needs to change the BS table, the DU sends according to the step 404 the BSR information via the CU (e.g., gNB-CU) either in the master node (MN, e.g. the network node), or alternatively, when possible, via the SN.

In any aspect, the technique may be applied to uplink (UL) transmission from the radio device to the network node (e.g., to the DU) or direct communications between radio devices, e.g., device-to-device (D2D) communications or sidelink (SL) communications.

Each of the device 100 and device 200 may be an entity of a base station (e.g., the network node) or of a radio device functioning as a gateway (e.g., a relay radio device). Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR).

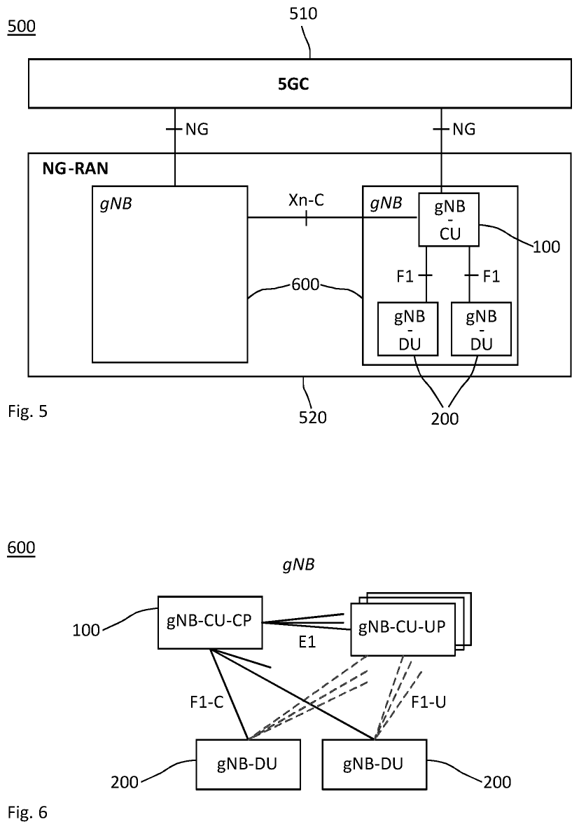

FIG. 5 schematically illustrates an example of an overall 5G RAN (NG-RAN) architecture. The radio network 500 comprises a core network (CN) 510 and a radio access network (RAN) 520. The RAN 520 comprises network nodes 600. The network nodes 600 may be interconnected (e.g., for control signaling) using an Xn interface, e.g., for mobility (e.g., handover) of the radio device or dual connectivity (DC) of the radio device.

At least one of the network nodes (e.g., a gNB) comprises a central unit (CU) 100 and one or more distributed units (DU) 200, which may embody the devices 100 and 200, respectively.

FIG. 6 schematically depicts an example of a network node 600, e.g., a gNB, with the split architecture. The gNB-CU 100 hosts the radio resource control (RRC) and the control plane part of the packet data convergence protocol (PDCP). The gNB-DU 200 hosts a radio link control (RLC) layer, a medium access control (MAC) layer and a physical (PHY) layer.

During Release 18, RAN2 of the 3GPP standardization has discussed the enhancement of existing buffer status report (BSR) to support the high data rate and low latency applications (e.g., extended reality, XR, applications).

Embodiments of the technique can enhance the scheduling of uplink resources (e.g., for XR) and/or achieve BSR improvements according to a 3GPP Release 18 Work Item (WI), e.g. including at least one of the following items.

According to a first item, one or more additional BS tables are selectable (e.g., by means of the BSR information and/or the BSR configuration) to reduce quantization errors in BSR reporting (e.g., for high bit rates).

According to a second item, delay knowledge (or delay information) of buffered data may be selectively included in the BSR (e.g., according to the BSR information and/or the BSR configuration). Examples of the delay knowledge comprising remaining time and/or distinguishing how much data is buffered for which delay. The delay information may be reported as part of BSR or as a further MAC control element (CE). Optionally, the delay information can be up to date considering e.g., scheduling and transmission delays.

According to a third item, the BSR information and/or the BSR configuration may be indicative of (e.g., additional) BSR triggering conditions, e.g. to allow timely availability of buffer status information.

In any aspect and any embodiment, the assistance information, the BSR information and/or the BSR configuration may be indicative of additional one or more BS tables, e.g., dynamically configured BS tables or configurable BSR tables, which may be constructed based on network parameters. This BSR table parameters can be reconfigured according to the change of application traffic statistics.

In any aspect and any embodiment, the assistance information, the BSR information, and/or the BSR configuration may be indicative of a configurable BS table where the key parameters, e.g., step size/min/max value of the buffer size range, are signaled by a network and a UE constructs a new BS table based on the indicated parameters.

Any embodiment of the first and/or second method or device aspect may use or modify a buffer status report in 5G.

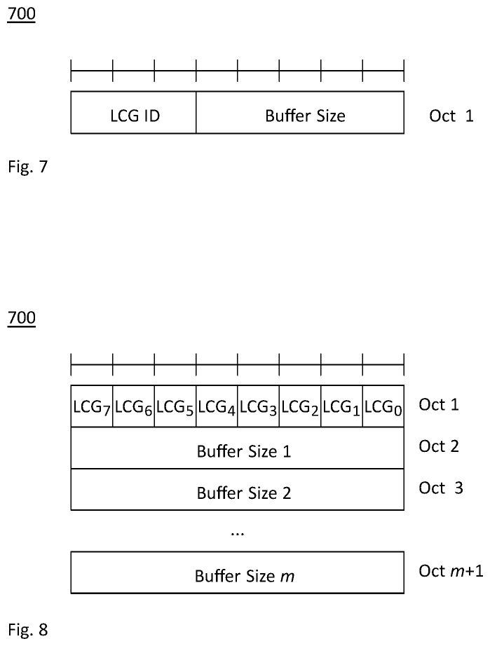

FIG. 7 schematically illustrates a short BSR format and/or short truncated BSR format of the BSR. The short BSR format may have conventionally a fixed size, which size is optionally modified according to the assistance information, the BSR information, and/or the BSR configuration. Alternatively or in addition, the short truncated BSR format may have conventionally a fixed size, which size is optionally modified according to the assistance information, the BSR information, and/or the BSR configuration.

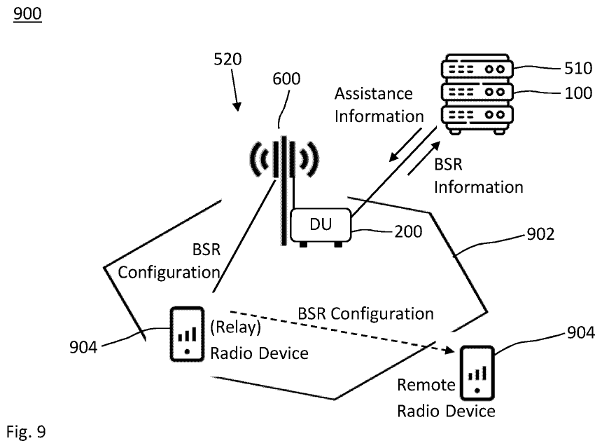

FIG. 8 schematically illustrates a long BSR format and/or long truncated BSR format of the BSR. The long BSR format may have conventionally a variable size, which size is optionally modified or specified according to the assistance information, the BSR information, and/or the BSR configuration. Alternatively or in addition, the long truncated BSR format may have conventionally a variable size, which size is optionally modified or specified according to the assistance information, the BSR information, and/or the BSR configuration.

The network node 600 (e.g., a gNB) may provide radio access in at least one cell 902 to radio devices 904.

As illustrated schematically in FIG. 9, the radio device (e.g., UE) 904 reports to the network node 600 the buffer status waiting for transmission in the MAC Control Element (CE) Buffer Status Report (BSR). There are currently 4 different BSR formats, which UEs 904 can send to the network node 600:

There are 3 types of BSR: regular BSR, periodic BSR, and padding BSR.

The regular BSR is triggered if UL data, for a logical channel which belongs to an LCG, becomes available to the MAC entity; and either this UL data belongs to a logical channel with higher priority than the priority of any logical channel containing available UL data which belong to any LCG; or none of the logical channels which belong to an LCG contains any available UL data. When more than one LCG has data available for transmission, then the UE uses the long BSR format and reports all LCGs which have data. However, if only one LCG has data, the short BSR format is used.

The periodic BSR is configured by the network. When configured, the UE reports periodically the BSR. When more than one LCG has data available for transmission, then the UE uses the long BSR format and reports all LCGs which have data. However, if only one LCG has data, the short BSR format is used.

The padding BSR is an opportunistic method to provide buffer status information to the network when the MAC PDU would contain a number of padding bits equal or larger than one of the BSR formats. In this case, the UE would add the padding BSR replacing the corresponding padding bits. In this case, the BSR format to be used depends on the number of padding bits, the number of logical channels which have data for transmissions, and the size of the BSR format. When more than one LCG has data for transmission, one of the following three formats is used: the short truncated BSR, the long BSR, or the long truncated BSR. The selection of the BSR format depends on the number of available padding bits. When only one LCG has data for transmission, then the short BSR format is used.

For a UE 904, one MAC PDU can contain at most one BSR MAC CE.

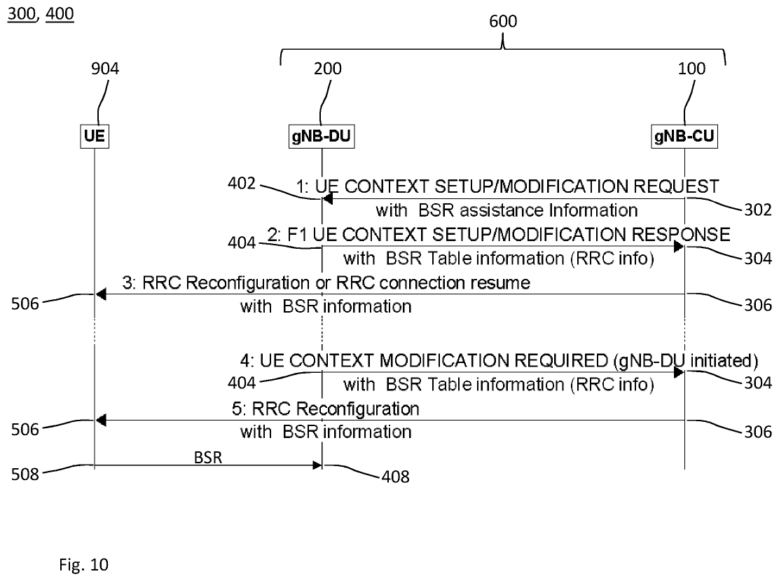

FIG. 10 schematically illustrates a signaling diagram resulting from embodiments of the devices 100 and 200 performing the methods of 300 and 400, respectively.

While the methods and devices are described herein according to their respective aspect and perspective, the skilled person appreciates that corresponding features and steps (e.g., as related by horizontal arrows in FIG. 10) as also disclosed for the other aspect or for a further radio device aspect.

The radio device aspect may comprise a step 506 of receiving the configuration message from the CU 100 (e.g., transmitted transparently through the layers of the DU 200). According to the received 506 BSR configuration, the radio device may transmit 508 the BSR.

The first (method or device) aspect may comprise at least one feature or step of the following gNB-CU embodiments.

In one embodiment, the gNB-CU prepares the BSR assistance information of the UE and signals it to the gNB-DU according to a step 302 of the method 300, e.g. during the F1 UE CONTEXT SETUP REQUEST or UE CONTEXT MODIFICATION REQUEST messages. Step 1 in the FIG. 10 provides an example.

In one embodiment, the assistance information 8 also referred to as BSR assistance information) includes the frequency of how the BSR table (i.e., the BS table in the BSR) should be updated, and/or the validity for how long the new BS table applies, and/or the list of cells 902 where the one or more BS tables should be applicable, and/or the logical channel IDs (LCIDs) for which each BS table is applicable, and/or a list of UEs 904 (or UE groups) for which the BS one or more tables should be applicable.

Alternatively or in addition, the BSR information provided by DU 200 to CU 100 (according to the steps 304 and 404) may be indicative of one or more thresholds (e.g. max buffer size or a maximum for a statistical observable at the CU) or for explicit information (e.g., an expected or required PDU size) from UE 904. The statistical observable (e.g. statistical information) may be based on measurement data for statistics collected and/or analyzed at the CU 100.

Examples for the network parameters, the explicit information, and/or the statistical observables may include a number of PDU flows, a PDU set size (e.g., a minimum, maximum and/or average thereof).

In one embodiment, the gNB-CU 100, upon receiving the BSR information (e.g., indicative of one or more UE BSR tables) from the DU 200 sends 306 an RRC message to the UE 904 with a new BSR configuration (e.g., with the BSR information). The step 3 or step 5 in FIG. 10 provide examples thereof. The new BSR configuration can be in the BSR-config information element (IE), or in another (e.g., dedicated) IE in RRC.

The second (method or device) aspect may comprise at least one feature or step of the following gNB-DU embodiments.

In one embodiment, the gNB-DU 200 reports (according to the step 404) the BSR information (e.g., BS table information) to the gNB-CU 100, e.g. as a response to a gNB-CU request 302, e.g., during initial UE configuration, or during event detection where the gNB-DU 200 detects that one or more BS tables should be updated. As non-limiting examples, the BSR information (e.g., the BS table information) may include one or more parameters to construct the (e.g., changed or updated) one or more BSR tables, such as a buffer size step size, minimum size and/or maximum size of a buffer size.

Herein, buffer size may refer to a range used for the reporting. Step size may refer to a quantization (or discretization) used for reporting the filling state of the buffer at the radio device 904.

Alternatively or in addition, the BSR information (e.g., the BS table information) may be an indication of the (e.g. wanted) BSR table type.

In one embodiment, the gNB-DU 200 sends 404 the BSR table information in the F1 UE CONTEXT SETUP RESPONSE or UE CONTEXT MODIFICATION RESPONSE (step 2), or UE CONTEXT MODIFICATION REQUIRED. Alternatively or in addition, the change of the BSR configuration (e.g., by the sending of the BSR information) may be initiated by the gNB-DU 200. Step 4 provides an example of the messages.

In one embodiment, UE CONTEXT MODIFICATION REQUIRED message (as an example of the control message) is sent 404 to the CU 100 when the DU 200 receives the updated information of UE traffic, e.g., average size of buffer size or receives the explicit indication from UE to request the change of BSR table information.

In another case, the DU 200 can initiate the message (e.g., the step 404) when the DU 200 detects itself the change of UE traffic situation. For example, when the average size of BSR reported from a UE is above or below one or more threshold values, the DU 200 sends 404 the message.

Optionally, the assistance information received in the step 402 may be indicative of the one or more threshold values.

In one embodiment, the BSR information (e.g., the information on the one or more BS tables) is sent 404 as an octet string from the DU 200 to CU 100 and/or as DU-to-CU RRC information. The CU may use the BSR information (e.g., the octet string and/or as DU-to-CU RRC information) to populate and transmit the RRC message to the UE 904 to build the BSR.

When information about more than one BSR table is included (e.g., in the BSR information or the BSR configuration), the gNB-DU 200 may also indicate the table index or table indexes which the UE should be used upon reception of the RRC message.

In a variant of any embodiment and any aspect, the network node 600 and a further network node 600 of the RAN 500 provide Dual Connectivity (DC) to the radio device.

In Dual Connectivity (DC) case, the gNB-DU 200 in the secondary node (SN) 600 may determine a new BS table.

In one embodiment, gNB-DU 200 in the SN 600 sends 404 the BSR information to the gNB-CU 100 in the SN 600, which sends the BSR information (e.g., BS table information) to the gNB-CU 100 in the master node (MN) 600. The gNB-CU 100 in the MN 600 sends the BS information, for gNB-DU 200 in the SN 600, or for both gNB-DU 200 in SN 600 and MN 600 when applicable, to the UE 904.

In another embodiment, the gNB-DU 200 in the SN 600 sends 404 the BSR information (e.g., BS table information) to gNB-CU 100 in the SN 600, which sends 306 (e.g., forwards) the BSR information (e.g. as the BSR configuration) to UE 904 via SRB3 when applicable.

In yet another embodiment, the gNB-CU 100 in the MN 600 may send 302 the assistance information (e.g., indicative or related to one or more BS tables) to the gNB-DU 200 in both MN 600 and SN 600.

The assistance information in the steps 302 and 402, and/or the BSR information in the steps 304 and 404, and/or the BSR configuration in the step 306 may be implemented based on, or by modifying the 3GPP document TS 38.473. Examples of the modifications are underlined in example messages (e.g., information elements) hereinbelow. The line “//skipped rows not changed” may indicate any number of further rows that are not included or not modified.

As a first example, a UE CONTEXT SETUP REQUEST message is sent 302 by the gNB-CU 100 to request the setup of a UE context. Direction: From gNB-CU 100 to gNB-DU 200.

The assistance information (e.g., the UE CONTEXT SETUP REQUEST message) may comprise at least one of the following lines, e.g. at least one of the lines in bold type.

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | O | | 9.3.1.5 | | YES | ignore |
| SpCell ID | M | | NR CGI | Special Cell as | YES | reject |
| | | | 9.3.1.12 | defined in TS | | |
| | | | | 38.321 [16]. | | |
| | | | | For handover | | |
| | | | | case, this IE is | | |
| | | | | considered as | | |
| | | | | target cell. | | |
| ServCellIndex | M | | INTEGER | | YES | reject |
| | | | (0 . . . 31, . . . ) | | | |
| SpCell UL | O | | Cell UL | | YES | ignore |
| Configured | | | Configured | | | |
| | | | 9.3.1.33 | | | |
| CU to DU RRC | M | | 9.3.1.25 | | YES | reject |
| Information | | | | | | |
| Candidate SpCell | | 0 . . . 1 | | | YES | ignore |
| List | | | | | | |
| >Candidate SpCell | | 1 . . . <maxnoofCandidateSpCells> | | | EACH | ignore |
| Item IEs | | | | | | |
| >>Candidate | M | | NR CGI | Special Cell as | — | |
| SpCell ID | | | 9.3.1.12 | defined in TS | | |
| | | | | 38.321 [16] | | |
| DRX Cycle | O | | DRX Cycle | | YES | ignore |
| | | | 9.3.1.24 | | | |
| Resource | O | | OCTET | Includes the | YES | ignore |
| Coordination | | | STRING | MeNB | | |
| Transfer | | | | Resource | | |
| Container | | | | Coordination | | |
| | | | | Information IE | | |
| | | | | as defined in | | |
| | | | | subclause | | |
| | | | | 9.2.116 of TS | | |
| | | | | 36.423 [9] for | | |
| | | | | EN-DC case or | | |
| | | | | MR-DC | | |
| | | | | Resource | | |
| | | | | Coordination | | |
| | | | | Information IE | | |
| | | | | as defined in | | |
| | | | | TS 38.423 [28] | | |
| | | | | for NGEN-DC | | |
| | | | | and NE-DC | | |
| | | | | cases. | | |
| SCell To Be | | 0 . . . 1 | | | YES | ignore |
| Setup List | | | | | | |
| >SCell to Be | | 1 . . . <maxnoofSCells> | | | EACH | ignore |
| Setup Item IEs | | | | | | |
| >>SCell ID | M | | NR CGI | SCell Identifier | — | |
| | | | 9.3.1.12 | in gNB | | |
| >>SCellIndex | M | | INTEGER | | — | |
| | | | (1 . . . 31) | | | |
| >>SCell UL | O | | Cell UL | | — | |
| Configured | | | Configured | | | |
| | | | 9.3.1.33 | | | |
| >>servingCellMO | O | | INTEGER | | YES | ignore |
| | | | (1 . . . 64) | | | |

//skipped rows not changed

| | | | |
|---|---|---|---|
| BSR Assistance | O | 9.3.1.X | Indicates the |
| Information | | | UE BSR |
| | | | assistance |
| | | | information |
| | | | for |
| | | | configuration |

| Range bound | Explanation |
|---|---|
| maxnoofSCells | Maximum no. of SCells allowed towards one UE, the |
| | maximum value is 32. |

Alternatively or in addition, a UE CONTEXT SETUP RESPONSE (e.g. in the step 404) may be sent by the gNB-DU 200 to confirm the setup of a UE context. Direction: From gNB-DU 200 to gNB-CU 100.

| | | | | | | |
|---|---|---|---|---|---|---|
| | | | IE type | | | |
| | | | and | | | Assigned |
| IE/Group Name | Presence | Range | reference | Semantics description | Criticality | Criticality |

| | | | | | |
|---|---|---|---|---|---|
| Message Type | M | 9.3.1.1 | | YES | reject |
| gNB-CU UE F1AP ID | M | 9.3.1.4 | | YES | reject |
| gNB-DU UE F1AP ID | M | 9.3.1.5 | | YES | reject |
| DU To CU RRC | M | 9.3.1.26 | | YES | reject |
| Information | | | | | |
| C-RNTI | O | 9.3.1.32 | C-RNTI allocated at the | YES | ignore |
| | | | gNB-DU | | |
| Resource | O | OCTET | Includes the SgNB | YES | ignore |
| Coordination | | STRING | Resource Coordination | | |
| Transfer | | | Information IE as | | |
| Container | | | defined in subclause | | |
| | | | 9.2.117 of TS 36.423 [9] | | |
| | | | for EN-DC case or | | |
| | | | MR-DC Resource | | |
| | | | Coordination | | |
| | | | Information IE as | | |
| | | | defined in TS 38.423 | | |
| | | | [28] for NGEN-DC and | | |
| | | | NE-DC cases. | | |

//skipped rows not changed

| | | | |
|---|---|---|---|
| BSR Information | O | 9.3.1.Y | Indicates the UE BSR |
| | | | Table mapping |
| | | | information |

| Range bound | Explanation |
|---|---|
| maxnoofSCells | Maximum no. of SCells allowed towards one UE, the |
| | maximum value is 32. |
| maxnoofSRBs | Maximum no. of SRB allowed towards one UE, the maximum |
| | value is 8. |
| maxnoofDRBs | Maximum no. of DRB allowed towards one UE, the |
| | maximum value is 64. |
| maxnoofDLUPTNLInformation | Maximum no. of DL UP TNL Information allowed towards |
| | one DRB, the maximum value is 2. |
| maxnoofBHRLCChannels | Maximum no. of BH RLC channels allowed towards one IAB- |
| | node, the maximum value is 65536. |
| maxnoofSLDRBs | Maximum no. of SL DRB allowed for NR sidelink |
| | communication per UE, the maximum value is 512. |
| maxnoofAdditionalPDCPDuplicationTNL | Maximum no. of additional UP TNL Information allowed |
| | towards one DRB, the maximum value is 2. |
| maxnoofUuRLCChannels | Maximum no. of Uu Relay RLC channels for L2 U2N relaying |
| | per Relay UE, the maximum value is 32. |
| maxnoofPC5RLCChannels | Maximum no. of PC5 Relay RLC channels allowed for L2 U2N |
| | relaying per Remote UE or Relay UE, the maximum value is |
| | 512. |

Alternatively or in addition, a UE CONTEXT MODIFICATION REQUEST message is sent 302 by the gNB-CU 100 to provide UE Context information changes to the gNB-DU 200. Direction: From gNB-CU 100 to gNB-DU 200.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| gNB-CU UE F1AP | M | | 9.3.1.4 | | YES | reject |
| ID | | | | | | |
| gNB-DU UE F1AP | M | | 9.3.1.5 | | YES | reject |
| ID | | | | | | |
| SpCell ID | O | | NR CGI | Special Cell as | YES | ignore |
| | | | 9.3.1.12 | defined in TS | | |
| | | | | 38.321 [16]. | | |
| | | | | For handover case, | | |
| | | | | this IE is | | |
| | | | | considered as | | |
| | | | | target cell. | | |
| ServCellIndex | O | | INTEGER | | YES | reject |
| | | | (0 . . . 31, . . . ) | | | |
| SpCell UL | O | | Cell UL | | YES | ignore |
| Configured | | | Configured | | | |
| | | | 9.3.1.33 | | | |
| DRX Cycle | O | | DRX Cycle | | YES | ignore |
| | | | 9.3.1.24 | | | |
| CU to DU RRC | O | | 9.3.1.25 | | YES | reject |
| Information | | | | | | |
| Transmission | O | | 9.3.1.11 | | YES | ignore |
| Action Indicator | | | | | | |
| Resource | O | | OCTET STRING | Includes the | YES | ignore |
| Coordination | | | | MeNB Resource | | |
| Transfer | | | | Coordination | | |
| Container | | | | Information IE | | |
| | | | | as defined in | | |
| | | | | subclause | | |
| | | | | 9.2.116 of TS | | |
| | | | | 36.423 [9] for | | |
| | | | | EN-DC case or | | |
| | | | | MR-DC Resource | | |
| | | | | Coordination | | |
| | | | | Information IE | | |
| | | | | as defined in TS | | |
| | | | | 38.423 [28] for | | |
| | | | | NGEN-DC and | | |
| | | | | NE-DC cases. | | |
| RRC | O | | 9.3.1.30 | | YES | ignore |
| Reconfiguration | | | | | | |
| Complete | | | | | | |
| Indicator | | | | | | |
| RRC-Container | O | | 9.3.1.6 | Includes the DL- | YES | reject |
| | | | | DCCH-Message | | |
| | | | | IE as defined in | | |
| | | | | subclause 6.2 of | | |
| | | | | TS 38.331 [8], | | |
| | | | | encapsulated in | | |
| | | | | a PDCP PDU. | | |
| SCell To Be Setup | | 0 . . . 1 | | | YES | ignore |
| List | | | | | | |
| >SCell to Be | | 1 . . . <maxnoofSCells> | | | EACH | ignore |
| Setup Item IEs | | | | | | |
| >>SCell ID | M | | NR CGI | SCell Identifier | — | |
| | | | 9.3.1.12 | in gNB | | |
| >>SCellIndex | M | | INTEGER (1 . . . 31) | | — | |
| >>SCell UL | O | | Cell UL | | — | |
| Configured | | | Configured | | | |
| | | | 9.3.1.33 | | | |
| >>servingCellMO | O | | INTEGER (1 . . . 64) | | YES | ignore |

//skipped rows not changed

| | | | | | |
|---|---|---|---|---|---|
| SDT Bearer | O | ENUMERATED | | YES | ignore |
| Configuration | | (true, . . . ) | | | |
| Query Indication | | | | | |
| BSR Assistance | O | 9.3.1.X | Indicates the UE | | |
| Information | | | BSR assistance | | |
| | | | information for | | |
| | | | configuration | | |

| Range bound | Explanation |
|---|---|
| maxnoofSCells | Maximum no. of SCells allowed towards one UE, the |
| | maximum value is 32. |

| Condition | Explanation |
|---|---|
| ifCHOcancel | This IE may be present if the CHO Trigger IE is present |
| | and set to “CHO-cancel”. |

Alternatively or in addition, a UE CONTEXT MODIFICATION RESPONSE message is sent 404 by the gNB-DU 200 to confirm the modification of a UE context. Direction: From gNB-DU 200 to gNB-CU 100.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| gNB-CU UE F1AP | M | 9.3.1.4 | | YES | reject |
| ID | | | | | |
| gNB-DU UE F1AP | M | 9.3.1.5 | | YES | reject |
| ID | | | | | |
| Resource | O | OCTET STRING | Includes the SgNB | YES | ignore |
| Coordination | | | Resource | | |
| Transfer | | | Coordination | | |
| Container | | | Information IE as | | |
| | | | defined in | | |
| | | | subclause 9.2.117 | | |
| | | | of TS 36.423 [9] | | |
| | | | for EN-DC case or | | |
| | | | MR-DC Resource | | |
| | | | Coordination | | |
| | | | Information IE as | | |
| | | | defined in TS | | |
| | | | 38.423 [28] for | | |
| | | | NGEN-DC and | | |
| | | | NE-DC cases. | | |
| DU To CU RRC | O | 9.3.1.26 | | YES | reject |
| Information | | | | | |

//skipped rows not changed

| | | | |
|---|---|---|---|
| BSR Information | O | 9.3.1.Y | Indicates the UE |
| | | | BSR Table |
| | | | mapping |
| | | | information |

It is remarked that the mapping may be based, e.g., on a table index and, for each table, a range index (e.g., for buffer size).

| Range bound | Explanation |
|---|---|
| maxnoofSRBs | Maximum no. of SRB allowed towards one UE, the maximum |
| | value is 8. |
| maxnoofDRBs | Maximum no. of DRB allowed towards one UE, the |
| | maximum value is 64. |
| maxnoofDLUPTNLInformation | Maximum no. of DL UP TNL Information allowed towards |
| | one DRB, the maximum value is 2. |
| maxnoofSCells | Maximum no. of SCells allowed towards one UE, the |
| | maximum value is 32. |
| maxnoofBHRLCChannels | Maximum no. of BH RLC channels allowed towards one IAB- |
| | node, the maximum value is 65536. |
| maxnoofSLDRBs | Maximum no. of SL DRB allowed for NR sidelink |
| | communication per UE, the maximum value is 512. |
| maxnoofAdditionalPDCPDuplicationTNL | Maximum no. of additional UP TNL Information allowed |
| | towards one DRB, the maximum value is 2. |
| maxnoofUuRLCChannels | Maximum no. of Uu Relay RLC channels for L2 U2N relaying |
| | per Relay UE, the maximum value is 32. |
| maxnoofPC5RLCChannels | Maximum no. of PC5 Relay RLC channels allowed for L2 U2N |
| | relaying per Remote UE or Relay UE, the maximum value is |
| | 512. |

Alternatively or in addition, a UE CONTEXT MODIFICATION REQUIRED message is sent 404 by the gNB-DU 200 to request the modification of a UE context. Direction: From gNB-DU 200 to gNB-CU 100.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| gNB-CU UE F1AP ID | M | 9.3.1.4 | | YES | reject |
| gNB-DU UE F1AP ID | M | 9.3.1.5 | | YES | reject |
| Resource | O | OCTET | Includes the | YES | ignore |
| Coordination | | STRING | SgNB Resource | | |
| Transfer | | | Coordination | | |
| Container | | | Information IE | | |
| | | | as defined in | | |
| | | | subclause | | |
| | | | 9.2.117 of TS | | |
| | | | 36.423 [9] for | | |
| | | | EN-DC case or | | |
| | | | MR-DC | | |
| | | | Resource | | |
| | | | Coordination | | |
| | | | Information IE | | |
| | | | as defined in | | |
| | | | TS 38.423 [28] | | |
| | | | for NGEN-DC | | |
| | | | and NE-DC | | |
| | | | cases. | | |
| DU To CU RRC | O | 9.3.1.26 | | YES | reject |
| Information | | | | | |

//skipped rows not changed

| | | | |
|---|---|---|---|
| BSR Information | O | 9.3.1.Y | Indicates the |
| | | | UE BSR Table |
| | | | mapping |
| | | | information |

| Range bound | Explanation |
|---|---|
| maxnoofSRBs | Maximum no. of SRB allowed towards one UE, the |
| | maximum value is 8. |
| maxnoofDRBs | Maximum no. of DRB allowed towards one UE, the |
| | maximum value is 64. |
| maxnoofDLUPTNLInformation | Maximum no. of DL UP TNL Information allowed |
| | towards one DRB, the maximum value is 2. |
| maxnoofBHRLCChannels | Maximum no. of BH RLC channels allowed towards one |
| | IAB-node, the maximum value is 65536. |
| maxnoofSLDRBs | Maximum no. of SL DRB allowed for NR sidelink |
| | communication per UE, the maximum value is 512. |
| maxnoofAdditionalPDCPDuplicationTNL | Maximum no. of additional UP TNL Information allowed |
| | towards one DRB, the maximum value is 2. |
| maxnoofCellsinCHO | Maximum no. cells that can be prepared for a |
| | conditional mobility. Value is 8. |
| maxnoofUuRLCChannels | Maximum no. of Uu Relay RLC channels for L2 U2N |
| | relaying per Relay UE, the maximum value is 32. |
| maxnoofPC5RLCChannels | Maximum no. of PC5 Relay RLC channels allowed for L2 |
| | U2N relaying per Remote UE or Relay UE, the maximum |
| | value is 512. |

Alternatively or in addition, DU-to-CU RRC Information may be an IE that contains the RRC Information that are sent from the gNB-DU 200 to the gNB-CU 100.

| | | | | | | |
|---|---|---|---|---|---|---|
| | | | IE type and | | | Assigned |
| IE/Group Name | Presence | Range | reference | Semantics description | Criticality | Criticality |

| | | | | | |
|---|---|---|---|---|---|
| CellGroupConfig | M | OCTET | CellGroupConfig, as | | |
| | | STRING | defined in TS 38.331 [8]. | | |
| MeasGapConfig | O | OCTET | MeasGapConfig as | | |
| | | STRING | defined in TS 38.331 [8]. | | |
| | | | For EN-DC/NGEN-DC | | |
| | | | operation, includes the | | |
| | | | gap for FR2, as requested | | |
| | | | by the gNB-CU via | | |
| | | | MeasConfig IE. | | |
| | | | For NG-RAN, NE-DC and | | |
| | | | MN for NR-NR DC, | | |
| | | | includes the gap(s) for | | |
| | | | FR1 and/or FR2, as | | |
| | | | requested by the gNB-CU | | |
| | | | via MeasConfig IE. | | |
| Requested | O | OCTET | requestedP-MaxFR1, as | | |
| P-MaxFR1 | | STRING | defined in TS 38.331 [8]. | | |
| | | | For EN-DC, NGEN-DC and | | |
| | | | NR-DC operation, this IE | | |
| | | | should be included. | | |
| DRX Long Cycle | O | INTEGER | Identical to the value of | | |
| Start Offset | | (0 . . . 10239) | the drx- | | |
| | | | LongCycleStartOffset IE | | |
| | | | within the DRX-Config as | | |
| | | | defined in TS 38.331 [8]. | | |
| | | | This field is not used in | | |
| | | | NR-DC. | | |
| Selected | O | OCTET | BandCombinationIndex, | YES | ignore |
| BandCombinationIndex | | STRING | as defined in TS 38.331 | | |
| | | | [8]. | | |
| | | | For (NG)EN-DC and NR DC | | |
| | | | operation, this IE should | | |
| | | | be included so that | | |
| | | | gNB-CU is informed of the | | |
| | | | selected Band | | |
| | | | Combination; if this IE is | | |
| | | | included, the gNB-CU | | |
| | | | uses this information to | | |
| | | | deduce the selected | | |
| | | | band. | | |
| Selected | O | OCTET | FeatureSetEntryIndex, as | YES | ignore |
| FeatureSetEntryIndex | | STRING | defined in TS 38.331 [8]. | | |
| | | | For (NG)EN-DC and NR DC | | |
| | | | operation, this IE should | | |
| | | | be included so that | | |
| | | | gNB-CU is informed of the | | |
| | | | selected FeatureSet. | | |
| Ph-InfoSCG | O | OCTET | PH-TypeListSCG, as | Yes | ignore |
| | | STRING | defined in TS 38.331 | | |
| | | | [8]. For MR-DC, this IE | | |
| | | | should be included so | | |
| | | | that gNB-CU is informed | | |
| | | | of the Power Headroom | | |
| | | | type for each serving cell | | |
| | | | in SN. | | |
| Requested | O | OCTET | BandCombinationIndex, | YES | ignore |
| BandCombinationIndex | | STRING | as defined in TS 38.331 | | |
| | | | [8]. | | |
| | | | This IE is used for the | | |
| | | | gNB-DU to request a new | | |
| | | | Band Combination. | | |
| Requested | O | OCTET | FeatureSetEntryIndex, as | YES | ignore |
| FeatureSetEntryIndex | | STRING | defined in TS 38.331 [8]. | | |
| | | | This IE is used for the | | |
| | | | gNB-DU to request a new | | |
| | | | Feature Set. | | |
| DRX Config | O | OCTET | DRX-Config, as defined in | YES | ignore |
| | | STRING | TS 38.331 [8]. | | |
| | | | This field is only used in | | |
| | | | NR-DC. | | |
| PDCCH | O | OCTET | pdcch- | YES | ignore |
| BlindDetectionSCG | | STRING | BlindDetectionSCG, as | | |
| | | | defined in TS 38.331 [8]. | | |
| | | | This IE is used between | | |
| | | | the MgNB-DU and the | | |
| | | | MgNB-CU. | | |
| Requested | O | OCTET | requestedPDCCH- | YES | ignore |
| PDCCH | | STRING | BlindDetectionSCG, as | | |
| BlindDetectionSCG | | | defined in TS 38.331 [8]. | | |
| | | | This IE is used between | | |
| | | | the SgNB-DU and the | | |
| | | | SgNB-CU. | | |
| Ph-InfoMCG | O | OCTET | PH-TypeListMCG, as | YES | ignore |
| | | STRING | defined in TS 38.331 [8]. | | |
| | | | For MR-DC, this IE should | | |
| | | | be included so that | | |
| | | | gNB-CU is informed of the | | |
| | | | Power Headroom type for | | |
| | | | each serving cell in MCG. | | |
| MeasGapSharingConfig | O | OCTET | MeasGapSharingConfig as | YES | ignore |
| | | STRING | defined in TS 38.331 [8]. | | |
| SL-PHY-MAC-RLC- | O | OCTET | SL-PHY-MAC-RLC-Config | YES | ignore |
| Config | | STRING | as defined in TS 38.331 | | |
| | | | [8]. | | |
| SL- | O | OCTET | SL- | YES | ignore |
| ConfigDedicatedEUTRA- | | STRING | ConfigDedicatedEUTRA- | | |
| Info | | | Info as defined in TS | | |
| | | | 38.331 [8]. | | |
| Requested | O | OCTET | RequestedP-MaxFR2, as | YES | ignore |
| P-MaxFR2 | | STRING | defined in TS 38.331 [8]. | | |
| | | | For NR-DC operation, this | | |
| | | | IE should be included. | | |
| SDT-MAC-PHY- | O | OCTET | SDT-MAC-PHY-CG-Config, | YES | ignore |
| CG-Config | | STRING | as defined in TS 38.331 | | |
| | | | [8]. | | |
| MUSIM- | O | OCTET | MUSIM-GapConfig as | YES | ignore |
| GapConfig | | STRING | defined in TS 38.331 [8]. | | |
| SL-RLC- | O | OCTET | sl-RLC- | YES | ignore |
| ChannelToAddModList | | STRING | ChannelToAddModList- | | |
| | | | r17, as defined in TS | | |
| | | | 38.331 [8] | | |
| InterFrequencyConfig- | O | ENUMERATED | Identical to the value of | YES | ignore |
| NoGap | | (true, . . . ) | the | | |
| | | | interFrequencyConfig- | | |
| | | | NoGap-r16 IE, as defined | | |
| | | | in TS 38.331 [8]. | | |
| ul-GapFR2-Config | O | OCTET | ul-GapFR2-Config-r17, as | YES | ignore |
| | | STRING | specifed in TS 38.331 [8]. | | |
| Buffer Status | O | OCTET | As defined in the 3GPP | | |
| Table | | STRING | document TS 38.331 [8]. | | |
| information | | | | | |

The 3GPP TS 38.331 document (e.g., version 17.3.0) may be used for specifying RRC signaling, which in this case may be tunneled via the CU 100 from the DU 200 to the UE 904.

Any of the embodiments (e.g., of the node 600) can be compliant with a current or future mobile telecommunications standard, e.g. according to the 3GPP documents TS 38.423, version 17.3.0, and/or TS 38.473

At least some embodiments can result in energy improvements at the node equipment and/or network level.

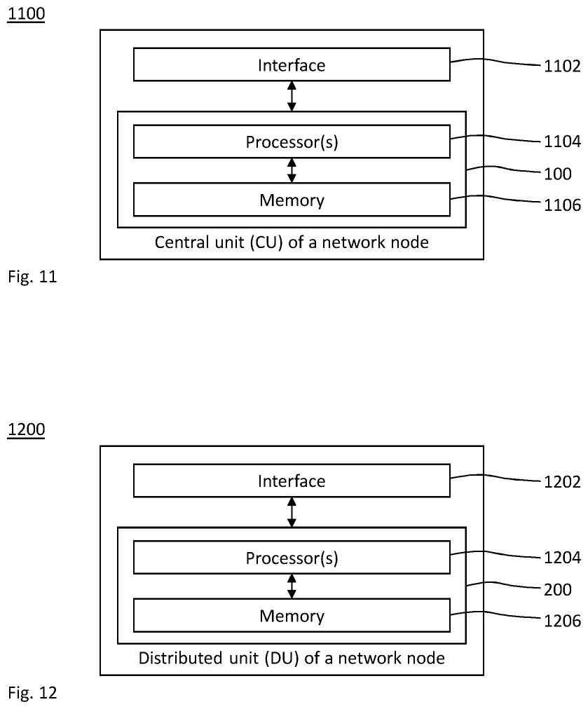

FIG. 11 shows a schematic block diagram for an embodiment of the device 100. The device 100 comprises processing circuitry, e.g., one or more processors 1104 for performing the method 300 and memory 1106 coupled to the processors 1104. For example, the memory 1106 may be encoded with instructions that implement at least one of the modules 102, 104 and 106.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1106, CU or network node functionality. For example, the one or more processors 1104 may execute instructions stored in the memory 1106. Such functionality may include providing various features and steps discussed herein, including any of the benefits disclosed herein. The expression “the device being operative to perform an action” may denote the device 100 being configured to perform the action.

As schematically illustrated in FIG. 11, the device 100 may be embodied by a CU 1100, e.g., functioning as a base station. The CU 1100 comprises a (e.g. radio) interface 1102 coupled to the device 100 for (e.g., radio) communication with one or more DUs, e.g., functioning as a base stations or radio heads.

FIG. 12 shows a schematic block diagram for an embodiment of the device 200. The device 200 comprises processing circuitry, e.g., one or more processors 1204 for performing the method 400 and memory 1206 coupled to the processors 1204. For example, the memory 1206 may be encoded with instructions that implement at least one of the modules 202, 204 and 206.

The one or more processors 1204 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1206, DU or network node functionality. For example, the one or more processors 1204 may execute instructions stored in the memory 1206. Such functionality may include providing various features and steps discussed herein, including any of the benefits disclosed herein. The expression “the device being operative to perform an action” may denote the device 200 being configured to perform the action.

As schematically illustrated in FIG. 12, the device 200 may be embodied by a DU 1200, e.g., functioning as a base station. The DU 1200 comprises a radio interface 1202 coupled to the device 200 for (e.g., radio) communication with one or more CUs 100 and/or a UE 904.

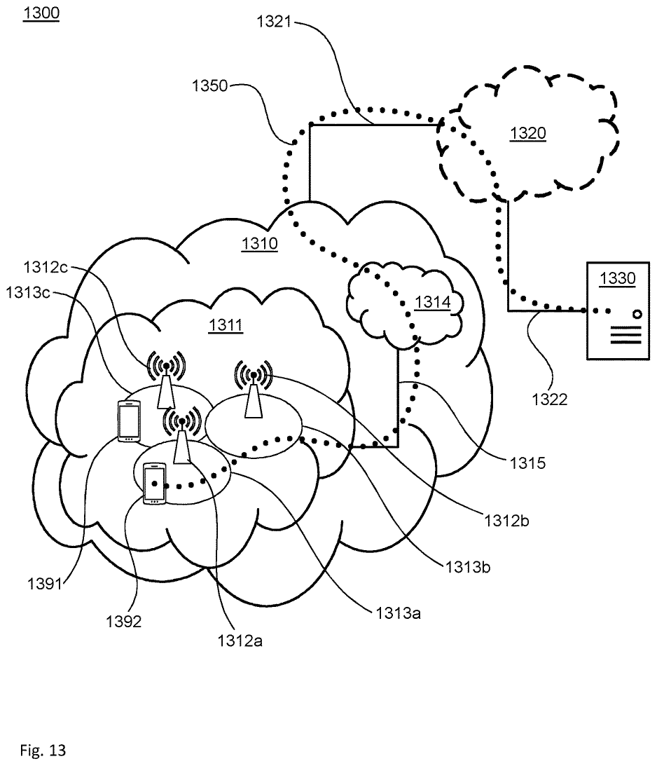

With reference to FIG. 13, in accordance with an embodiment, a communication system 1300 includes a telecommunication network 1310, such as a 3GPP-type cellular network, which comprises an access network 1311, such as a radio access network, and a core network 1314. The access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to the core network 1314 over a wired or wireless connection 1315. A first user equipment (UE) 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Any of the base stations 1312 may embody the device 100 and/or 200.

The telecommunication network 1310 is itself connected to a host computer 1330, which may be embodied in the hardware and/or software of a standalone server, a cloud-implemented server, a distributed server or as processing resources in a server farm. The host computer 1330 may be under the ownership or control of a service provider, or may be operated by the service provider or on behalf of the service provider. The connections 1321, 1322 between the telecommunication network 1310 and the host computer 1330 may extend directly from the core network 1314 to the host computer 1330 or may go via an optional intermediate network 1320. The intermediate network 1320 may be one of, or a combination of more than one of, a public, private or hosted network; the intermediate network 1320, if any, may be a backbone network or the Internet; in particular, the intermediate network 1320 may comprise two or more sub-networks (not shown).

The communication system 1300 of FIG. 13 as a whole enables connectivity between one of the connected UEs 1391, 1392 and the host computer 1330. The connectivity may be described as an over-the-top (OTT) connection 1350. The host computer 1330 and the connected UEs 1391, 1392 are configured to communicate data and/or signaling via the OTT connection 1350, using the access network 1311, the core network 1314, any intermediate network 1320 and possible further infrastructure (not shown) as intermediaries. The OTT connection 1350 may be transparent in the sense that the participating communication devices through which the OTT connection 1350 passes are unaware of routing of uplink and downlink communications. For example, a base station 1312 need not be informed about the past routing of an incoming downlink communication with data originating from a host computer 1330 to be forwarded (e.g., handed over) to a connected UE 1391. Similarly, the base station 1312 need not be aware of the future routing of an outgoing uplink communication originating from the UE 1391 towards the host computer 1330.

By virtue of the method 300 and/or 400 being performed by any one of the base stations 1312, the performance or range of the OTT connection 1350 can be improved, e.g., in terms of increased throughput and/or reduced latency. More specifically, the host computer 1330 may indicate to the RAN 500 or the network node 600 or the CU (e.g., through the UE on an application layer) a QoS of the traffic, which may trigger a change of the BS table in the BSR.

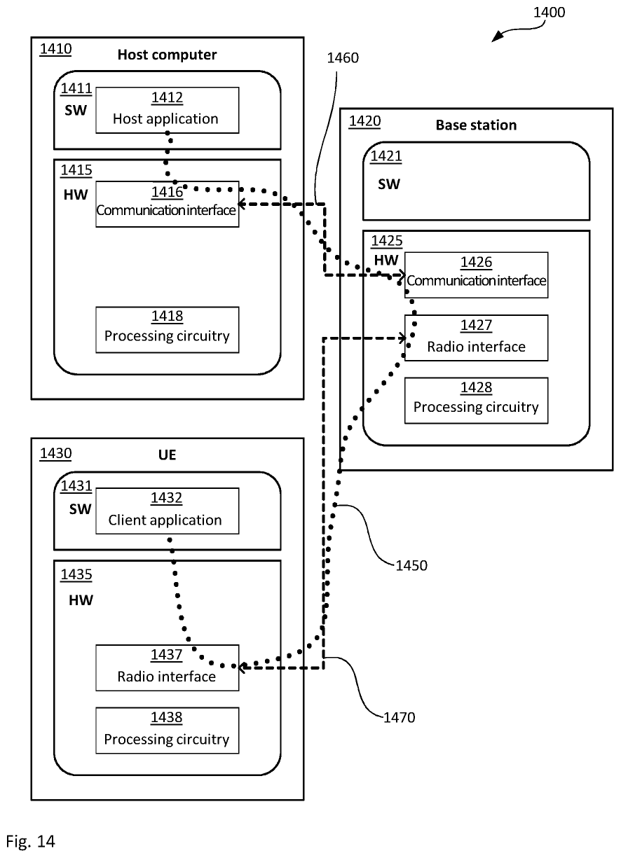

Example implementations, in accordance with an embodiment of the UE, base station and host computer discussed in the preceding paragraphs, will now be described with reference to FIG. 14. In a communication system 1400, a host computer 1410 comprises hardware 1415 including a communication interface 1416 configured to set up and maintain a wired or wireless connection with an interface of a different communication device of the communication system 1400. The host computer 1410 further comprises processing circuitry 1418, which may have storage and/or processing capabilities. In particular, the processing circuitry 1418 may comprise one or more programmable processors, application-specific integrated circuits, field programmable gate arrays or combinations of these (not shown) adapted to execute instructions. The host computer 1410 further comprises software 1411, which is stored in or accessible by the host computer 1410 and executable by the processing circuitry 1418. The software 1411 includes a host application 1412. The host application 1412 may be operable to provide a service to a remote user, such as a UE 1430 connecting via an OTT connection 1450 terminating at the UE 1430 and the host computer 1410. In providing the service to the remote user, the host application 1412 may provide user data, which is transmitted using the OTT connection 1450. The user data may depend on the location of the UE 1430. The user data may comprise auxiliary information or precision advertisements (also: ads) delivered to the UE 1430. The location may be reported by the UE 1430 to the host computer, e.g., using the OTT connection 1450, and/or by the base station 1420, e.g., using a connection 1460.

The communication system 1400 further includes a base station 1420 provided in a telecommunication system and comprising hardware 1425 enabling it to communicate with the host computer 1410 and with the UE 1430. The hardware 1425 may include a communication interface 1426 for setting up and maintaining a wired or wireless connection with an interface of a different communication device of the communication system 1400, as well as a radio interface 1427 for setting up and maintaining at least a wireless connection 1470 with a UE 1430 located in a coverage area (not shown in FIG. 14) served by the base station 1420.

The communication interface 1426 may be configured to facilitate a connection 1460 to the host computer 1410. The connection 1460 may be direct, or it may pass through a core network (not shown in FIG. 14) of the telecommunication system and/or through one or more intermediate networks outside the telecommunication system. In the embodiment shown, the hardware 1425 of the base station 1420 further includes processing circuitry 1428, which may comprise one or more programmable processors, application-specific integrated circuits, field programmable gate arrays or combinations of these (not shown) adapted to execute instructions. The base station 1420 further has software 1421 stored internally or accessible via an external connection.

The communication system 1400 further includes the UE 1430 already referred to. Its hardware 1435 may include a radio interface 1437 configured to set up and maintain a wireless connection 1470 with a base station serving a coverage area in which the UE 1430 is currently located. The hardware 1435 of the UE 1430 further includes processing circuitry 1438, which may comprise one or more programmable processors, application-specific integrated circuits, field programmable gate arrays or combinations of these (not shown) adapted to execute instructions. The UE 1430 further comprises software 1431, which is stored in or accessible by the UE 1430 and executable by the processing circuitry 1438. The software 1431 includes a client application 1432. The client application 1432 may be operable to provide a service to a human or non-human user via the UE 1430, with the support of the host computer 1410. In the host computer 1410, an executing host application 1412 may communicate with the executing client application 1432 via the OTT connection 1450 terminating at the UE 1430 and the host computer 1410. In providing the service to the user, the client application 1432 may receive request data from the host application 1412 and provide user data in response to the request data. The OTT connection 1450 may transfer both the request data and the user data. The client application 1432 may interact with the user to generate the user data that it provides.

It is noted that the host computer 1410, base station 1420 and UE 1430 illustrated in FIG. 14 may be identical to the host computer 1330, one of the base stations 1312a, 1312b, 1312c and one of the UEs 1391, 1392 of FIG. 13, respectively. This is to say, the inner workings of these entities may be as shown in FIG. 14, and, independently, the surrounding network topology may be that of FIG. 13.

In FIG. 14, the OTT connection 1450 has been drawn abstractly to illustrate the communication between the host computer 1410 and the UE 1430 via the base station 1420, without explicit reference to any intermediary devices and the precise routing of messages via these devices. Network infrastructure may determine the routing, which it may be configured to hide from the UE 1430 or from the service provider operating the host computer 1410, or both. While the OTT connection 1450 is active, the network infrastructure may further take decisions by which it dynamically changes the routing (e.g., on the basis of load balancing consideration or reconfiguration of the network).

The wireless connection 1470 between the UE 1430 and the base station 1420 is in accordance with the teachings of the embodiments described throughout this disclosure. One or more of the various embodiments improve the performance of OTT services provided to the UE 1430 using the OTT connection 1450, in which the wireless connection 1470 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1450 between the host computer 1410 and UE 1430, in response to variations in the measurement results. The measurement procedure and/or the network functionality for reconfiguring the OTT connection 1450 may be implemented in the software 1411 of the host computer 1410 or in the software 1431 of the UE 1430, or both. In embodiments, sensors (not shown) may be deployed in or in association with communication devices through which the OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of the OTT connection 1450 may include message format, retransmission settings, preferred routing etc.; the reconfiguring need not affect the base station 1420, and it may be unknown or imperceptible to the base station 1420. Such procedures and functionalities may be known and practiced in the art. In certain embodiments, measurements may involve proprietary UE signaling facilitating the host computer's 1410 measurements of throughput, propagation times, latency and the like. The measurements may be implemented in that the software 1411, 1431 causes messages to be transmitted, in particular empty or “dummy” messages, using the OTT connection 1450 while it monitors propagation times, errors etc.

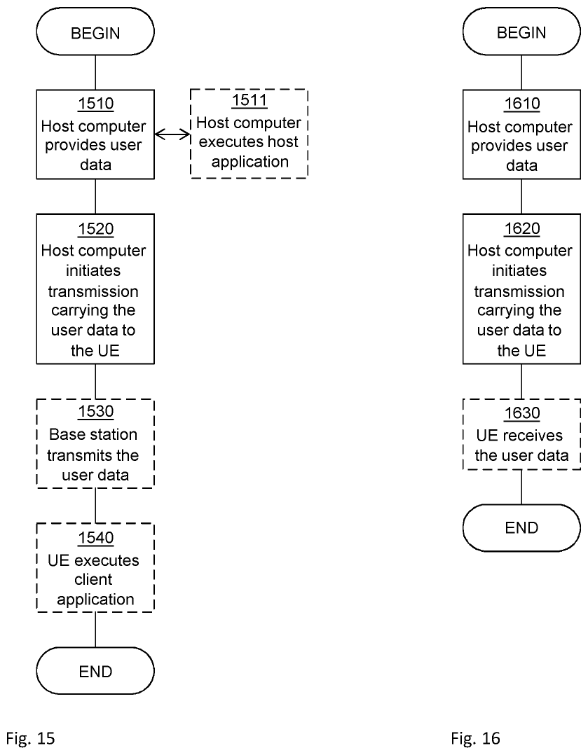

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this paragraph. In a first step 1510 of the method, the host computer provides user data. In an optional substep 1511 of the first step 1510, the host computer provides the user data by executing a host application. In a second step 1520, the host computer initiates a transmission carrying the user data to the UE. In an optional third step 1530, the base station transmits to the UE the user data which was carried in the transmission that the host computer initiated, in accordance with the teachings of the embodiments described throughout this disclosure. In an optional fourth step 1540, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this paragraph. In a first step 1610 of the method, the host computer provides user data. In an optional substep (not shown) the host computer provides the user data by executing a host application. In a second step 1620, the host computer initiates a transmission carrying the user data to the UE. The transmission may pass via the base station, in accordance with the teachings of the embodiments described throughout this disclosure. In an optional third step 1630, the UE receives the user data carried in the transmission.

As has become apparent from above description, at least some embodiments of the technique support providing BSR information (e.g., buffer status table information) in a split network node (e.g., a split gNB architecture).

The configuration message may comprise a MAC-CellGroupConfig information element (IE) and/or an additionalBSR-TableAllowed information element (IE). The additionalBSR-TableAllowed IE may specify Logical Channel Groups (LCGs) for which an additional BSR table is permitted, e.g. based on the configuration message sent to the radio device 904. Alternatively or in addition, each bit position in the additionalBSR-TableAllowed IE may correspond to a specific LCG ID, such that the LCG is permitted to use the additional BSR table only if its corresponding bit is set to 1, thereby enabling a granular control over the use of the additional BSR table on a per LCG basis.

Alternatively or in addition, the configuration message sent to the radio device 904 may include instructions for the radio device to report back the usage status of the additional BSR table, e.g. for each allowed LCG, based on the additionalBSR-TableAllowed IE (e.g., including but not limited to the frequency of usage and the types of data transmitted using the additional BSR table, thereby allowing the CU 100 to dynamically assess and adjust the permission for utilizing the additional BSR table for optimizing network efficiency and radio device performance).

Alternatively or in addition, the sent 306 configuration message further instructs the radio device 904 to initiate a further BSR procedure using the additional BSR table (e.g., for any LCG identified by the additionalBSR-TableAllowed IE as allowed), when a predetermined condition is met (e.g., a threshold amount of data pending transmission or a specified change in channel conditions) Alternatively or in addition, the BSR procedure includes reporting the buffer status using the additional BSR table specifically designed to enhance the reporting for high data rates or low latency applications, providing a mechanism for the CU 100 to more accurately allocate resources based on the nuanced data needs of the radio device 904.

For example, if an LCG-DSR-Config IE is included in the control message (e.g., a DU to CU RRC Information IE), e.g. contained in the UE CONTEXT SETUP RESPONSE message, the gNB-CU 100 shall, if supported, use it as described in TS 38.331 (e.g., version 17.3.0). If the Additional BSR-Table Allowed IE is also included in the control message (e.g., a DU to CU RRC Information IE), the gNB-CU 100 shall, if supported, use it to know or configure whether the UE 904 is allowed to utilize the additional BSR table for the indicated logical channel group.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following list of claims.

Abbreviations have the meaning stated above in context. Alternatively or in addition, the following explanation may apply.

| Abbreviation | Explanation |
|---|---|
| QFI | QoS Flow Index |
| eMBB | Enhanced Mobile Broadband |
| NR | New Radio |
| 5GC | 5G Core Network |
| XR | Extended Reality |
| RAN | Radio Access Nework |
| Fps | Frames per second |
| TB | Transport Block |
| LCID | Logical Channel Identity |
| LCG | Logical Channel Group |
| UL | Uplink |
| PBR | Prioritized Bit Rate |
| LCP | Logical Channel Prioritization |
| BSD | Bucket Size Duration |
| IE | Information Element |
| PDU | Protocol Data Unit |
| NW | Network |
| SDAP | Service Data Adaption Protocol |
| SDU | Service Data Unit |
| IP | Internet Protocol |
| RRC | Radio Resource Control |
| UE | User Equipment |

1. A method performed by a central unit, CU, of a network node of a radio access network, RAN:
receiving a control message from a distributed unit, DU, the control message comprising BSR information related to a configuration of a buffer status report, BSR, to be reported by a radio device; and
sending a configuration message to the radio device, the configuration message being indicative of the configuration of the BSR to be reported by the radio device.

2. The method of claim 1, wherein the control message is indicative of the radio device and/or the BSR information is specific for the radio device, and/or
wherein the control message is indicative of a logical channel group, LCG, and/or the BSR information is specific for a logical channel group, and/or
wherein the BSR information applies to all radio devices radio-connected to or through the DU.

3. The method of claim 1, wherein the control message is received from the DU of the network node, or
wherein the control message is received from the DU of a secondary node, SN, other than the network node, optionally wherein the network node as a master node, MN, and the SN provide dual connectivity, DC, to the radio device.

4. The method of claim 1, wherein the radio device is radio-connected to the DU or through the DU.

5. The method of claim 1, wherein the BSR information comprised in the received control message is indicative of one or more channel condition network parameters and/or application traffic statistics; and/or
wherein the BSR information comprised in the received control message is indicative of a threshold value for measurement data or statistics of the measurement data measured at the CU; and/or
wherein the method further comprises determining the configuration of the BSR based on the received BSR information or changing the BSR configuration if the measured data or the measured statistics exceeds or falls below the threshold value.

6. The method of claim 1, wherein the BSR information comprised in the received control message and/or the configuration indicated in the sent configuration message is indicative of at least one of:
a change of a buffer status table to be used in the BSR;
a configuration of a buffer status table;
a buffer status table to be used in the BSR from the radio device, optionally an index of the buffer status table;
a step size of a buffer size range reported in the BSR, optionally an index for the step size;
a number of steps of a buffer size range reported in the BSR, optionally an index for the step size;
a minimum value of a buffer size range reported in the BSR, optionally an index for the minimum value; and
a maximum value of a buffer size range reported in the BSR, optionally an index for the maximum value.

7. The method of claim 1, wherein the BSR information comprised in the received control message and/or the configuration indicated in the sent configuration message is indicative of at least one of:
whether a packet delay budget, PDB, of data pending at the radio device is to be included in the BSR;
whether a delay of data pending at the radio device is to be included in the BSR; and
whether a remaining time budget of data pending at the radio device is to be included in the BSR.

8. The method of claim 1, wherein the BSR information comprised in the received control message and/or the configuration indicated in the sent configuration message is indicative of a BSR triggering condition for triggering the radio device to transmit the BSR.

9. The method of claim 1, further comprising:
sending assistance information from the CU to the DU, wherein the control message is received in response to the sent assistance information.

10. The method of claim 9, wherein the assistance information is indicative of at least one of:
measurement data or statistics of the measurement data, optionally wherein the measurement data comprises at least one of network parameters, application traffic of the radio device, sizes of protocol data units, PDUs, transmitted by the radio device and/or wherein the statistics comprise statistics on network parameters, statistics on application traffic of the radio device, statistics of PDU sizes, optionally a minimum size or a maximum size or an average size or size distribution;
a requirement of the radio device and/or a quality of service, QoS, required by an application performed by the radio device or a service used by the radio device and/or PDU size requirement; and
an update frequency with which the BSR configuration or the buffer status table is to be updated, and/or a validity for how long the BSR configuration or the buffer status table applies, and/or one or more logical channel identity, LCIDs, for which a buffer status table is applicable or is to be updated, and/or a one or more radio devices for which the buffer status table applies or is to be updated.

11. The method of claim 9, wherein the assistance information is sent in a request message for a context of the radio device, and/or
wherein the assistance information is sent in a UE CONTEXT SETUP REQUEST message or a UE CONTEXT MODIFICATION REQUEST message.

12. The method of claim 1, wherein at least one of the assistance information is sent or the control message is received responsive to a change in at least one of: the channel condition, the network parameters, the application traffic statistics, measurement data, and the statistics of the measurement data.

13. The method of claim 1, wherein the control message is received through an F1 interface between the CU and the DU of the network node.

14. The method of claim 1, wherein the received control message is indicative of a setup or a modification of a context of the radio device, and/or
wherein the received control message is an F1 UE CONTEXT SETUP RESPONSE message or an F1 UE CONTEXT MODIFICATION RESPONSE message or an UE CONTEXT MODIFICATION REQUIRED messages.

15. The method of claim 1, wherein the sent configuration message is a radio resource control, RRC, message.

16. The method of claim 1, wherein the sent configuration message comprises a BSR-Config information element, IE, used to configure buffer status reporting and/or a MAC-CellGroupConfig IE comprising the configuration of the BSR.

17. A method performed by a distributed unit, DU, of a network node of a radio access network, RAN:
sending a control message to a central unit, CU, the control message comprising BSR information related to a configuration of a buffer status report, BSR, to be reported by a radio device,
wherein the control message triggers the CU to configure the radio device to report the BSR according to the BSR information.

18-19. (canceled)

20. A central unit of a network node comprising memory operable to store instructions and processing circuitry operable to execute the instructions, such that the central unit is operable to:
receive a control message from a distributed unit, DU, the control message comprising BSR information related to a configuration of a buffer status report, BSR, to be reported by a radio device; and
send a configuration message to the radio device, the configuration message being indicative of the configuration of the BSR to be reported by the radio device.

21-23. (canceled)

24. A distributed unit of a network node comprising memory operable to store instructions and processing circuitry operable to execute the instructions, such that the distributed unit is operable to:
send a control message to a central unit, CU, the control message comprising BSR information related to a configuration of a buffer status report, BSR, to be reported by a radio device,
wherein the control message triggers the CU to configure the radio device to report the BSR according to the BSR information.

25-32. (canceled)
